(19) United States
(12) Patent Application Publication
(10) Pub. No.: US 2003/0015909 A1
(43) Pub. Date: Jan. 23, 2003

(54) Hub and wheel restraint system

(76) Inventor: Edward G. Meek JR., Knoxville, TN (US)

Correspondence Address: Jack K. Greer, Jr., Pitts & Brittian, P.C., P.O. Box 51295, Knoxville, TN, 37950-1295, US

(21) Appl. No.: 09/909,314

(22) Filed: Jul. 19, 2001

(51) Int. Cl. B60B 25/00

(52) U.S. Cl. 301/10.1

(57) ABSTRACT

A hub and wheel restraint system for a wheel assembly including a hub assembly disposed on a spindle extendable through the wheel assembly. The hub assembly includes a means for rotation disposed proximal about said spindle. A flanged connector is removably connected to an outer end of the hub assembly for prevention of the release of the hub assembly from the spindle during rotation of the wheel assembly. The hub and wheel restraint system further includes a restraint rim that is removably connected to an outer face of a wheel rim and wheel center disc of the wheel assembly. The restraint rim is utilized with or without the flanged connector. The restraint rim provides a locking system for maintaining the connection of the wheel rim and wheel center disc during rotation of the wheel assembly.

### CROSS-REFERENCE TO RELATED APPLICATIONS

Not Applicable.

### STATEMENT REGARDING FEDERALLY SPONSORED RESEARCH OR DEVELOPMENT

Not Applicable

### BACKGROUND OF THE INVENTION

1. Field of Invention

This invention relates generally to the field of wheel hub systems for connecting to wheel rims and wheel axles. More specifically, the present invention relates to a hub and wheel restraint system for maintaining the integrity of connections between a hub assembly and a wheel assembly.

2. Description of the Related Art

Prior wheel assemblies for transporting mobile homes and utility trailer applications typically utilize a wheel rim that is connectable to a center wheel disc having a central opening through which one end of an axle is positioned. The center wheel disc includes a central opening through which a hub assembly is insertable for connection to the axle. The hub assembly may include a central spindle having at least one rotating bearing ring mounted on the spindle to provide rotation of the center wheel disc of the wheel rim in relation to the hub assembly of each wheel assembly. The hub assembly is typically locked onto the spindle utilizing a connector such as a hex nut and a cotter pin insertable through the hex nut and through the width of the end of the spindle. The center wheel disc of the wheel is connectable to the wheel rim by a plurality of arms or spokes that terminate in webs bolted or welded against an interior circumference of the wheel rim. A tire is mounted on an exterior circumference of the wheel rim. For mobile home transport trailers and utility trailers, it is a benefit that each respective wheel disc and rim can be disassembled after transport of loads on the trailer frames, for stacking and/or stowing of the trailer frames on a vehicle during a return trip to the point of origination for reassembly and reuse.

For mobile home transport trailers, the preferred weight limits for the axles and tires are commonly exceeded, leading to frequent failures of axles, wheel assemblies, and/or tires during transport of a mobile home. A problem exists when, due to improper tire mounting and inadequate torque applied to the bolts connecting a wheel disc and rim, the center wheel disc and wheel rim may become imbalanced, leading to wear on the center wheel disc and wheel rim, and eventual separation from the wheel axle. Another problem exists when attachable spacer units are connected to the bolts inserted through the center wheel disc and the wheel rim. As the center wheel disc and wheel rim rotate during transport of a mobile home, the spacer units may separate from the wheel rim, therefore allowing the bolts to work loose, resulting in deterioration of the wheel rim and potential failure of the attachment of the wheel rim to the center wheel disc. Another common failure during transport includes misalignment of the central spindle of a hub assembly, leading to wobble of the spindle and wear of the bearings of the hub assembly. With repetitive wobble of the spindle at high speeds during transport of overloaded mobile home trailers, the locking hex nuts, and/or cotter pins, and/or bearing rings can separate from the spindle, with resulting ejection of the bearings and/or ejection of the hub assembly from the spindle during transport on public highways.

The mobile home trailers are utilized repetitively with minimal attention to wheel assembly connections. Also, similarly designed utility trailers having wheel assembly systems described above are further utilized for transport of earthmoving equipment such as bulldozers and backhoe tractors. When mobile home trailers and similarly designed utility trailers are overloaded during transport, frequent failures occur on highways and/or metropolitan roads. Partial failures include rapid deterioration of the hub assemblies, leading to ejection of bearings, spindles, and/or connector bolts at high rotational speeds from a wheel assembly. Catastrophic failures include separation of wheels from an axle during transport of the mobile home, with the wheels becoming deadly projectiles on public highways.

There is a need for a hub and wheel restraint system that provides an enhanced technique for maintaining connection between each utility trailer wheel assembly and hub assembly during transport of utility trailers. There is a further need for a hub and wheel restraint system that provides a hub assembly connector which remains securely attached to a spindle despite wear and deterioration of the hub assembly during use and repetitive disassembly and reassembly for use in transporting heavy loads on utility trailers.

### BRIEF SUMMARY OF THE INVENTION

In accordance with the present invention, there is provided a hub and wheel restraint system for a wheel assembly including a hub assembly disposed on an outer end of a spindle extendable through a central portion of the wheel assembly, the hub assembly including a means for rotation disposed proximal to said spindle. A flanged connector is removably connected to the outer end of the spindle whereby the flanged connector prevents the release of the hub assembly from the spindle during rotation of the wheel assembly disposed on an end of the axle. The flanged connector includes a flange end extended generally perpendicular to the length axis of the spindle, and a connector end opposed from the flange end, with the connector end having a first means of attachment disposed on the connector end. The first means of attachment on the connector end is connectable to a second means of attachment on the outer end of the spindle. A means for locking the first means of attachment to the second means of attachment may include at least one restraint pin insertable through the width diameter of the connector end of the flanged connector when attached to the outer end of the spindle. The flanged connector provides a restraint for maintaining the integrity of means for rotation proximate the spindle during rotation. Further, the flanged connector maintains a restraint for maintaining the connection of the hub assembly proximate the spindle during deterioration of the means for rotation under the weight of heavy loads.

The hub and wheel restraint system further includes a restraint rim that is removably connected to an outer face of a wheel disc of the wheel assembly. The restraint rim is utilized with or without the flanged connector. The restraint rim provides a locking system for enhanced connection of a wheel disc to a wheel rim of the wheel assembly. The hub and wheel restraint system provides an apparatus and a method for maintaining connection between utility trailer wheel assemblies and associated hub assemblies despite wear and degradation of the means for rotation and/or failure of connections between the wheel disc and the wheel rim of the wheel assembly during transport.

### BRIEF DESCRIPTION OF THE SEVERAL VIEWS OF THE DRAWINGS

The present invention is illustrated in the drawings in which:

FIG. 1 is a representation of one embodiment of a wheel assembly and a hub and wheel restraint system of the present invention;

FIG. 2 is an exploded view of one embodiment of a hub and wheel restraint system illustrating a hub assembly and a flanged connector of the present invention;

FIG. 3 is a partial exploded view of the wheel assembly of FIG. 1, illustrating a restraint apparatus removably mounted thereto;

FIG. 4 is a side view of an alternative embodiment of the restraint apparatus of FIG. 3, illustrating a plurality of restraint members attached to a wheel assembly; and

FIG. 5 is a representation of the prior art for a wheel assembly.

### DETAILED DESCRIPTION OF THE INVENTION

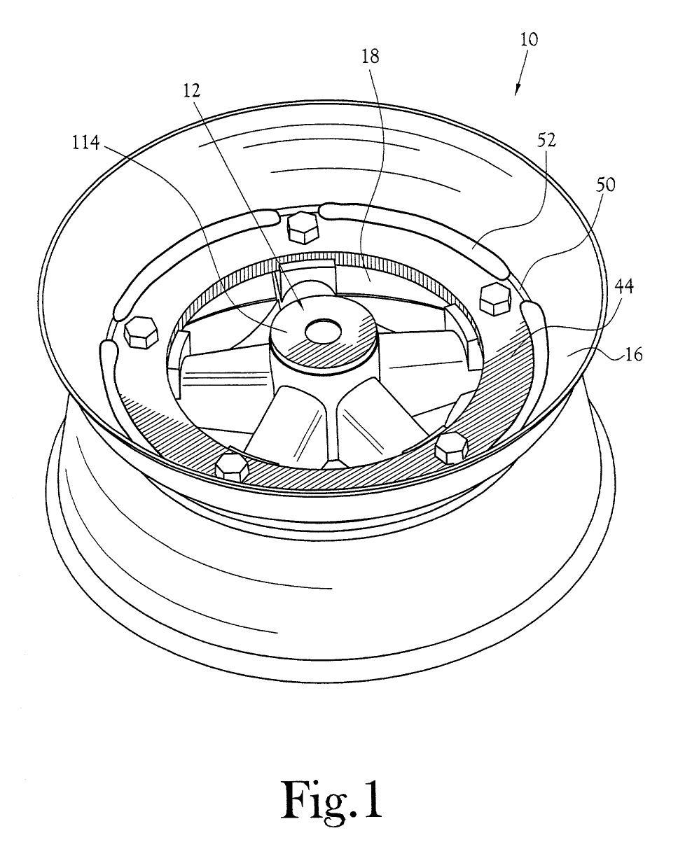

A hub and wheel restraint system for utility trailers is illustrated generally as a hub and wheel restraint system 10 in FIG. 1. The hub and wheel restraint system 10 includes a hub 12 and hub assembly 112 disposed on an outer end of a spindle 138 that is extendable through a central opening 24 of a wheel assembly 14. The hub and wheel restraint system 10 further includes a restraint rim 44 that is removably mounted against an inner rim flange 20 along an interior circumference of an outwardly faced wheel rim 16 of a wheel rim of the wheel assembly 14.

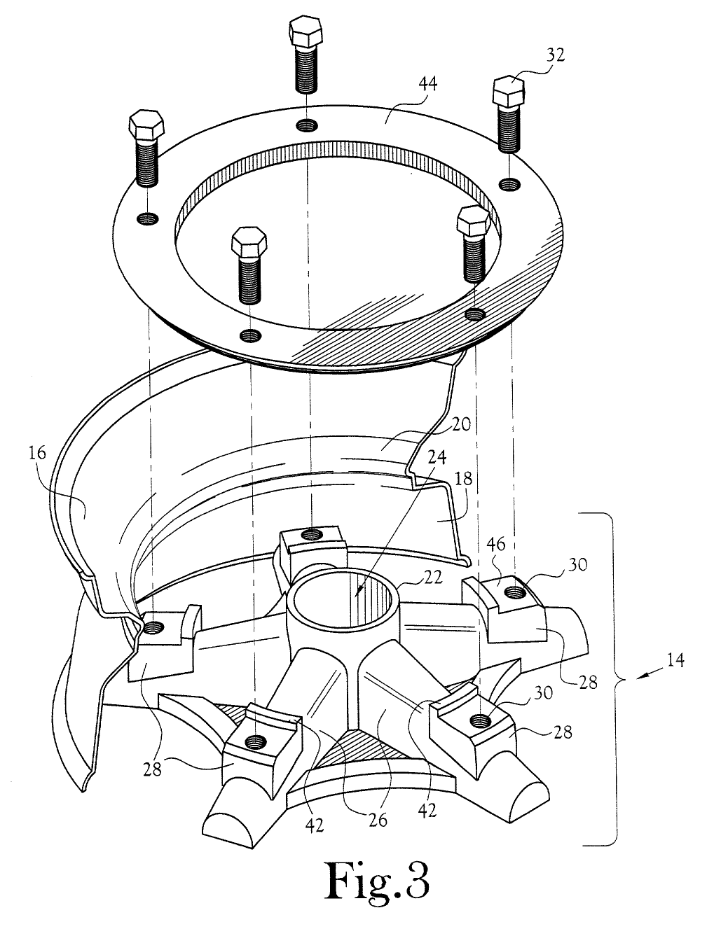

As illustrated in FIGS. 1 and 3, the wheel assembly 14 for a utility trailer typically includes a wheel rim having an outwardly faced wheel rim 16 and an inner rim surface 18. The outwardly faced wheel rim 16 includes an inner rim flange 20 against which a wheel disc 22 support member is disposed. The wheel disc 22 typically includes a central hub portion having a central opening 24 therein. The wheel disc 22 further includes a plurality of spokes 26, such as the five spokes 26 illustrated in FIGS. 1 and 3, with each spoke having a web 28, also know as an ear or a foot, positioned at the same selected distance on each of the spokes 26 of the wheel disc 22. Each web 28 includes a flange member 42 and a flat surface 46 which are positioned proximal to the inner rim flange 20 when the wheel disc 22 is inserted within the wheel rim.

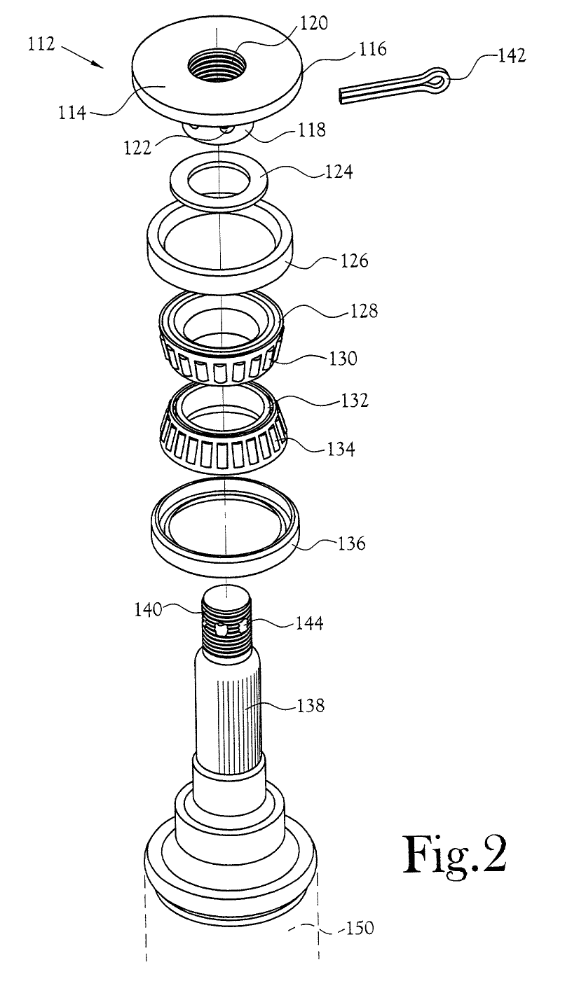

One embodiment of the hub 12 and hub assembly 112 (see FIGS. 1 and 2) includes a flanged connector 114 that is removably connected to the outer end of the spindle 138. The flanged connector 114 includes a flanged end 116 and a connector end 118. The flanged end 116 is positioned on the outer end of the spindle 138. The connector end 118 includes a first means of attachment on the end portion, either exterior or interior of the end portion. The first means of attachment 120 include a threaded or grooved interior hole through the flanged connector 114, or a slotted interior circumference (not shown) providing an attaching means known to those skilled in the art for attaching a cylindrical member onto a generally cylindrical end of the spindle 138.

The flanged connector 114, when attached to the spindle 138 and inserted within the central opening 24 of the wheel assembly 14 (see FIGS. 1 and 3), serves to prevent the components of the hub assembly 112 from disengaging from respective positions about the shaft of the spindle 138 due to deterioration of the components from imbalances associated with the spindle 138, and/or due to forces imposed by overloading of an axle 150 of a utility trailer to which the hub 12 and hub assembly 112 and wheel assembly 14 are attached.

One embodiment of the hub assembly 112 is illustrated in FIG. 2. The outer end of the spindle 138 includes a second means of attachment 140 that is connectable to the first means of attachment 120 of the flanged connector 114, to provide a secure fit of the connector end 118 to the outer end of the spindle 138. The second means of attachment 140 may include a threaded or grooved exterior diameter of the outer end of the spindle 138, or a similar means of attachment known to those skilled in the art for attaching a cylindrical member onto a generally cylindrical end of the spindle 138. A means for locking the connector end 118 to the outer end of the spindle 138 may include a plurality of holes 122 through connector end 118 and holes 144 through the outer end of the spindle 138, into which a locking means such as a cotter pin 142 is removably insertable.

The hub assembly 112 further includes at least one means for rotating of the wheel assembly 14 in relation to said hub assembly 112. The rotating means is positioned proximate to, or around the spindle 138. The rotating means may include a pair of bearing rings 128, 132 known to those skilled in the art. The means for rotation may include the following components, identified in order of orientation from the outer end attached to the connector end 118, to the interior end of the spindle 138 oriented toward the axle 150 of the utility trailer. The order of orientation may be altered by those skilled in the art to provide an alternative embodiment of the means for rotation. Fitted against the connector end 118 is at least one spacer 124 and an outer lubricant retainer ring 126. An outer bearing ring 128 is positioned proximal to the shaft of the spindle 138. The outer bearing ring 128 includes a plurality of bearings 130 that rotate freely within the bearing ring 128. The plurality of bearings 130 are in contact with the central hub portion of the wheel hub opening 24 to allow the wheel assembly 14 to rotate freely in relation to the spindle 138.

Positioned along the spindle 138 and interior of the outer bearing ring 128 is an inner bearing ring 132 including a plurality of bearings 134 that rotate freely within the inner bearing ring 132. The inner plurality of bearings 134 are in contact with the interior portion of the central hub portion of the wheel hub opening 24 to allow the wheel assembly 14 to rotate freely in relation to the spindle 138. Interior of the inner bearing ring 132 is inner lubricant retainer ring 136 (see FIG. 2). One or more spacer rings may be added for positioning around the spindle 138 for spacing of the means for rotation from the base of the spindle attached to the axle 150.

Due to the plurality of elements providing support, and the elements providing means for rotation, it is important for the above described example of the order of orientation, and the integrity of each component of the hub assembly 112, be maintained for proper operation of the hub 12 and hub assembly 112. If a spindle is not aligned properly, and/or a connector end is loosely connected to the spindle 138, the bearings of the hub assembly 112 may deteriorate and a damaging motion of the spindle 138 may be generated during highway speeds attained by a utility trailer. Further, if adequate deterioration of the bearings 130, 134 and hub assembly 112 are allowed, the bearings 130, 134, bearing rings 128, 132, and/or the spacer ring 124 may disengage from respective positions about the shaft of the spindle 138, with resulting deterioration of the components and release of parts expelled from the hub assembly during elevated speeds attained by a utility trailer in transport. The flanged connector 114 assists with maintenance of the integrity of components and the order of orientation of components of the hub assembly 112 around the spindle 138. Further, the flanged end 116 functions to divert the release of loose parts to provide a protective cap to impede the projection of parts from the outer end of the spindle 138.

One embodiment of the restraint system for the wheel assembly 14 includes the wheel disc 22 removably attachable proximal to the inner rim flange 20 with a plurality of connectors such as bolts 32 that are insertable into respective holes 30 through each web 28 and spoke 26. To maintain an integral fit of the wheel disc 22 against the inner rim flange 20, a restraint rim 44 of a selected width is positionable against a surface of the inner rim flange 20 to form a junction 50 with the inner rim flange 20. The restraint rim 44 includes a plurality of spaced apart holes therethrough, into which respective connector bolts 32 are insertable for connection into respective hole 30 through each web 28 and spoke 26. The restraint rim 44 provides a locking system for enhanced connection of a wheel disc 22 to a wheel rim of the wheel assembly 14. For additional security to ensure that the restraint rim 44 remains against the inner rim flange 20 without sideways slippage if one or two connector bolts 32 become detached from the restraint rim 44, the restraint rim 44 can be attached by a weld or other bonding method at a plurality of weld junctions 52 against the inner rim flange 20 of the wheel rim. With or without the weld junctions 52, the restraint rim 44 provides a generally stable restraint that reduces the ability of a wheel disc 22 to release outwards from an outwardly faced wheel rim 16 if a plurality of the connecting bolts 32 become detached from the wheel assembly 14. The restraint rim 44 may be constructed of a metal such as steel and other generally rigid materials.

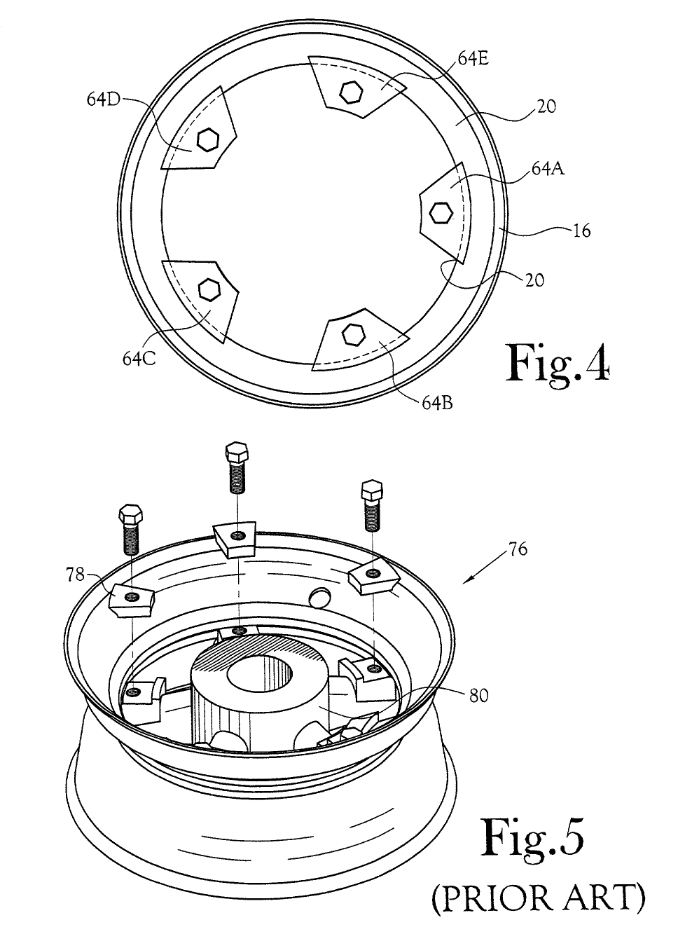

As illustrated in FIG. 4, an alternate embodiment of the restraint rim 44 may include a plurality of restraint members 64A-E, each attachable over a portion of the inner rim flange 20. The plurality of restraint members 64A-E are sized to removably mount against portions of the inner rim flange 20, with connection to the wheel assembly 14 by each of a plurality of connectors such as bolts 32 (not shown in FIG. 4). Each of the plurality of restraint members 64A-E are sized to extend a selected width distance along the surface of the inner rim flange 20 proximal the outwardly faced wheel rim 16 of the wheel rim, with each one of the plurality of bolts 32 being insertable through each one respective restraint member 64A-E. The plurality of restraint members 64A-E may be constructed of a metal such as steel and other generally rigid materials.

As illustrated generally in FIG. 5, in prior applications, upon insertion of bolts into each respective hole within the spokes of a center portion 80 of a wheel rim 76, a shim 78 shaped as a wedge, would be positioned under the head of each bolt for positioning against the inner circumference of the wheel rim 76. Each shim 78 applied pressure against the inner circumference to maintain a tight fit of the center portion 80 against the interior of the wheel rim 76. Typically during operation of utility trailers under heavy loading, such as transport of mobile homes, one or more shims 78 become detached from the connector bolts, or rotated so as to not apply pressure against the inner circumference of the wheel rim 76, therefore allowing a loss of integrity of the connection of the wheel rim 76 with the center portion 80. After numerous shims 78 become detached, the risk will increase that an imbalance and/or misalignment occurs between the wheel rim 76 and the center portion 80, therefore increasing the chance for separation of the wheel rim 76 from the center portion 80. The restraint rim 44, or the plurality of restraint members 64A-E, replaces the prior utilized shims 78, thereby providing a generally stable restraint that reduces the likelihood of a wheel disc 22, or a wheel center portion 80, to be released outwards from a wheel rim despite loss of a plurality of the connector bolts 32.

While numerous embodiments are illustrated and described, it will be recognized that alternative embodiments of the disclosed invention may be employed without departing from the spirit and the scope of the invention as set forth in the appended claims. Further, the disclosed invention is intended to cover all modifications and alternative systems falling within the spirit and the scope of the invention as set forth in the disclosure herein and the appended claims.

Having thus described the aforementioned invention, I claim:

1. A hub restraint apparatus attachable to a wheel assembly rotatably disposed on an axle, comprising:
a hub assembly disposed about a spindle attached in alignment with a length axis of the axle, said spindle having an outer end extendable through a central portion of the wheel assembly, said hub assembly including a means for rotation for the wheel assembly in relation to said hub assembly; and
a flanged connector removably connected to said hub assembly disposed about said spindle;
whereby said flanged connector prevents the release of said hub assembly from said spindle during rotation of the wheel assembly disposed on the axle.

2. The hub restraint apparatus of claim 1, wherein said flanged connector including:
a flange end extended generally perpendicular to an axis of said spindle;
a connector end opposed from said flange end, said connector end having a first means of attachment disposed on said connector end;
whereby said connector end is connectable to a second means of attachment disposed on said outer end of said spindle; and
a means for locking said connector end on said outer end of said spindle;
whereby said flanged connector maintains the integrity of said means of rotation disposed proximal to said spindle during rotation of the wheel assembly relative to said hub assembly and said spindle while preventing said means for rotation from disengaging from said spindle during rotation of the wheel assembly.

3. The hub restraint apparatus of claim 1, the wheel assembly including:
a wheel rim having an outer faced rim surface, the wheel rim having an interior circumference bounding an opening therethrough, the wheel rim having a perimeter rim onto which a tire is mountable; and
a wheel disc positionable within the opening through the wheel rim, said wheel disc connectable by a plurality of connectors against the interior circumference of the wheel rim.

4. The hub restraint apparatus of claim 3, including a restraint rim sized to removably mount proximal to the interior circumference of the wheel rim of the wheel assembly, said restraint rim connectable to said wheel disc by the plurality of connectors, said restraint rim sized to extend a selected width distance along the outer faced rim surface from the interior circumference of the wheel rim.

5. The hub restraint apparatus of claim 3, including a plurality of restraint members sized to removably mount about each of the plurality of connectors, each of said plurality of restraint members sized to extend a selected width distance along the outer faced rim surface from the interior circumference of the wheel rim, each one of the plurality of connectors being insertable through one respective restraint member.

6. A hub and wheel restraint system attachable to a wheel assembly having a connectable wheel rim and wheel disc rotatably disposed on an axle, comprising:
a hub assembly disposed proximal to a spindle attached in alignment with a length dimension of the axle, said spindle having an outer end extendable through a central portion of the wheel disc of the wheel assembly, said hub assembly including a rotating means for rotation of the wheel assembly in relation to said hub assembly;
a flanged connector removably connected to said hub assembly, said flanged connector disposed proximal to said outer end of said spindle; and
a restraint rim removably mounted proximal to an interior circumference of the wheel rim and wheel disc of the wheel assembly, said restraint rim connectable at a junction against the wheel rim and wheel disc by a plurality of connectors;
whereby said flanged connector maintains the integrity of said rotating means disposed proximal to said spindle during rotation of the wheel assembly relative to said hub assembly;
whereby said restraint rim maintains the integrity of the wheel assembly during rotation of the wheel assembly relative to said hub assembly disposed on the axle.

7. The hub and wheel restraint system of claim 6, wherein said flanged connector including:
a flange end extended generally perpendicular to an axis of said spindle;
a connector end opposed from said flange end, said connector end having a first means of attachment disposed on said connector end;
whereby said connector end is connectable to a second means of attachment disposed on said outer end of said spindle; and
a means for locking said connector end on said outer end of said spindle;
whereby said flanged connector maintains the integrity of said rotating means disposed proximal to said spindle during rotation of the wheel assembly relative to said hub assembly and said spindle while preventing said rotating means from disengaging from said spindle during rotation of the wheel assembly.

8. The hub and wheel restraint system of claim 7, wherein said first means of attachment includes a plurality of threads or grooves on said connector end, with said connector end connectable to said second means of attachment disposed on said outer end of said spindle.

9. The hub and wheel restraint system of claim 8, wherein said second means of attachment includes a plurality of grooves or threads on said outer end of said spindle.

10. The hub and wheel restraint system of claim 6, wherein the wheel assembly including:
the wheel rim having said interior circumference bounding the opening therethrough, the wheel rim having a perimeter rim surface onto which a tire is mountable; and
the wheel disc positionable within the opening through said interior circumference of said wheel rim, the wheel disc connectable by a plurality of connectors against the interior circumference of said wheel rim; and
said restraint rim removably mounted proximal to said interior circumference of the wheel rim, said restraint rim maintained in a locked position against the wheel rim and attached to the wheel disc by said plurality of connectors;
whereby the wheel assembly is rotatable with said restraint rim in said locked position against the wheel rim.

11. The hub and wheel restraint system of claim 6, including a plurality of restraint members sized to removably mount about each of the plurality of connectors, each of said plurality of restraint members sized to extend a selected width distance along the outer face of the wheel rim from the interior circumference of the wheel rim, each one of the plurality of connectors being insertable through one respective restraint member.

12. An improved hub and wheel restraint system attachable to a wheel assembly rotatably disposed on an end of an axle, the wheel assembly including a wheel rim having an outwardly faced rim surface having an interior circumference bounding an opening therethrough, and a wheel rim support member positionable within the opening through the outwardly faced rim surface, the wheel rim support member positionable by a plurality of connectors against the interior circumference of the opening through the outwardly faced rim surface, the wheel rim support member having a center hub opening therein, wherein the improvement comprising:
a hub assembly disposed on a spindle having a first end attached to an end of the axle, said spindle insertable through the center hub opening of the wheel rim support member, said hub assembly including a means for rotation disposed proximal to said spindle to provide rotation of the wheel assembly in relation to said hub assembly;
a flanged connector removably connected to said spindle at an outer end of said spindle opposed from said first end of said spindle attached to the end of the axle; and
a restraint rim removably mounted by a plurality of connectors against the interior circumference of the opening through the outwardly faced rim surface;
whereby said flanged connector maintains the integrity of said means for rotation disposed proximal to said spindle during rotation of the wheel assembly relative to said hub assembly;
whereby said restraint rim maintains the integrity of the wheel assembly during rotation of the wheel assembly relative to said hub assembly disposed on said spindle attached to the end of the axle.

13. The improved hub and wheel restraint system of claim 12, wherein said flanged connector including:
a flange end extended generally perpendicular to said spindle;
a connector end opposed from said flange end, said connector end having a first means of attachment disposed on said connector end;
whereby said connector end is connectable to a second means of attachment disposed on said outer end of said spindle; and
a means for locking said connector end on said outer end of said spindle;
whereby said flanged connector maintains the integrity of said means of rotation disposed proximal to said spindle during rotation of the wheel assembly relative to said hub assembly while preventing said means for rotation from disengaging from said spindle during rotation of the wheel assembly.

14. The improved hub and wheel restraint system of claim 13, wherein said restraint rim removably mounted adjacent the interior circumference of the opening through the outwardly faced rim surface, said restraint rim being sized to extend a selected width distance along the outwardly faced rim surface of the wheel rim from the interior circumference of the opening through the wheel rim.
